(19) United States
(12) Patent Application Publication
(10) Pub. No.: US 2008/0270153 A1
(43) Pub. Date: Oct. 30, 2008

(54) SERVICE ORIENTED ARCHITECTURE (SOA) LIFECYCLE MODEL MIGRATION

(75) Inventors: Stanislav Drapkin, Richmond Hill (CA); Mark W. Hubbard, Maple (CA); Ross McKegney, Toronto (CA); Pablo D. Irassar, Markham (CA); Shiva Mohan, London (CA); Yali Wang, North York (CA); Xin Yuan, North York (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/742,234

(22) Filed: Apr. 30, 2007

(51) Int. Cl. G06Q 50/00

(52) U.S. Cl. 705/1

(57) ABSTRACT

Embodiments of the present invention address deficiencies of the art in respect to SOA systems migration and provide a method, system and computer program product for SOA lifecycle model migration. In one embodiment of the invention, a method for migrating a process model in a monolithic application to an SOA lifecycle model in an SOA based system can be provided. The method can include selecting process steps implemented by code assets in a code base for the monolithic application, mapping the selected process steps to corresponding ones of the code assets, and determining entry and exit points in the code assets for establishing callbacks into services defining the SOA based system. Thereafter, callbacks to the determined entry and exit points can be established and the services can be deployed.

### BACKGROUND OF THE INVENTION

1. Field of the Invention

The present invention relates to the field of developing service oriented architecture (SOA) based systems and more particularly to the migration of business processes hard-coded within the execution of a monolithic system to configurable processes executing in an SOA based system.

2. Description of the Related Art

As businesses and consumers become further interconnected through computer communications networks such as the global Internet and local intranets, the commerce sites and companion computing applications which integrate interactions between businesses and consumers alike are becoming ever more complex. Addressing the explosion of business to business and business to consumer interactions on-line, information technologists increasingly focus on architecting and implementing complete commerce site solutions to reflect the entire life cycle of a business in lieu of integrating multiple, disparate applications which when combined reflect the business life cycle. Consequently, as modern commerce sites can be both large and distributed, commerce systems have been configured to deploy complete e-commerce systems in as seamless a fashion as possible.

It is now a common trend that traditional, stand-alone, commerce oriented applications are produced from one or more components which can be individually re-used to create business processes for different solutions. Each of these components can expose itself as a set of reusable business functions, also referred to as “services” comporting with computing standards for deploying enterprise level logic that facilitate an open service oriented architecture (SOA). An SOA essentially can be defined as a system where all exposed business and technical functions are in the form of reusable services. These reusable services can communicate with each other to engage either in simple data passing between two or more services, or in activity coordination by two or more services.

In a SOA, a client can invoke an operation on a service to perform a function and, optionally the client can receive a response. Invoked services are generally business functions configured to fulfill the needs of business customers, whether those customers are individual consumers or other businesses. The functions can be grouped into various services where each service can specialize in functions such as catalog management, shopping cart management, credit card transaction processing, sales tax computation and the like. By utilizing an SOA, services in a commerce solution can interoperate with other business processes in a larger commerce solution involving one or more separate business entities and one or more separate consumer entities.

Independent software vendors view SOA as a superior platform upon which solutions can be delivered and maintained for customers. In particular, in as much as customers frequently seek change requests for delivered solutions, legacy monolithic applications appear inflexible relative to SOA based systems. Thus, independent software vendors often attempt migrations from legacy component based multi-tier enterprise systems such as those built upon Java 2 Platform, Enterprise Edition (J2EE) to a more flexible SOA system. Achieving an effective migration, however, depends largely on the individual expertise of the independent software vendor. While high-level, generic guidelines for migrating a J2EE based system to an SOA based system have been published, little or no documentation on a precise process for migration has been provided.

### BRIEF SUMMARY OF THE INVENTION

Embodiments of the present invention address deficiencies of the art in respect to SOA systems migration and provide a novel and non-obvious method, system and computer program product for SOA lifecycle model migration. In one embodiment of the invention, a method for migrating a process model in a monolithic application to an SOA lifecycle model in an SOA based system can be provided. The method can include selecting process steps implemented by code assets in a code base for the monolithic application, mapping the selected process steps to corresponding ones of the code assets, and determining entry and exit points in the code assets for establishing callbacks into services defining the SOA based system. Thereafter, callbacks to the determined entry and exit points can be established and the services can be deployed.

In one aspect of the embodiment, selecting process steps implemented by code assets in a code base for the monolithic application can include selecting a subset of the process steps for migration to the SOA based system. In another aspect of the embodiment, selecting a subset of the process steps for migration to the SOA based system can include quantifying a frequency of requested change requests for the different process steps, and selecting process steps for inclusion in the subset according to a quantified threshold frequency of requested change requests. In yet another aspect of the embodiment, establishing callbacks to the determined entry and exit points can include determining a feasibility of establishing the callbacks and establishing callbacks only where feasible for different ones of the code assets and otherwise re-coding remaining ones of the code assets for deployment in a business process server for the SOA based system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for SOA lifecycle model migration;

FIG. 2 is an application development data processing system configured for SOA lifecycle model migration; and,

FIG. 3 is a flow chart illustrating a process for SOA lifecycle model migration.

### DETAILED DESCRIPTION OF THE INVENTION

Embodiments of the present invention provide a method, system and computer program product for SOA lifecycle model migration. In accordance with an embodiment of the present invention, different process steps in a legacy monolithic application can be identified through process modeling and a subset of the process steps can be selected for mapping with existing code assets in a code base for the monolithic application. Entry and exit points in each of the mapped code assets can be determined and callbacks can be established between the entry and exit points and services defined for the SOA based system. Finally, the services can be deployed in a business process server for the SOA based system. In this way, the legacy monolithic application can be effectively migrated to an SOA based system.

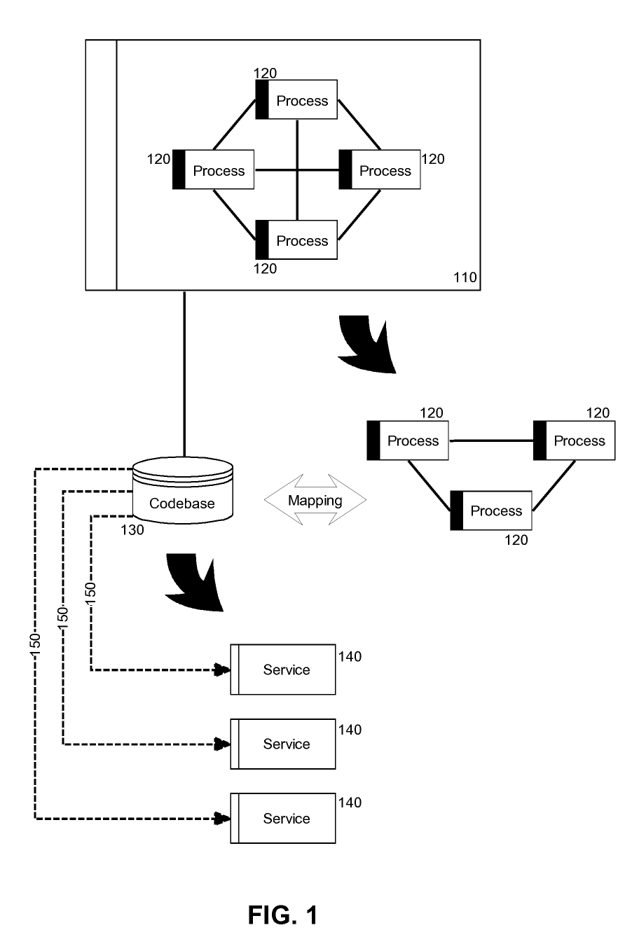

In illustration, FIG. 1 is a pictorial illustration of a process for SOA lifecycle model migration. As shown in FIG. 1, a legacy monolithic application 110 of components 120 can be analyzed to select a subset of the components 120 for migration to an SOA based system. The selected subset of components 120 can be mapped to corresponding segments of code that comprise the underlying code base 130 for the monolithic application 110. Once mapped, entry and exit points can be determined for the corresponding segments of code for use in establishing callbacks between the selected subset of components 120 and the corresponding segments of code in the code base 130. Finally, callbacks 150 can be established between the entry and exit points of the code segments and corresponding services 140 in the SOA based system.

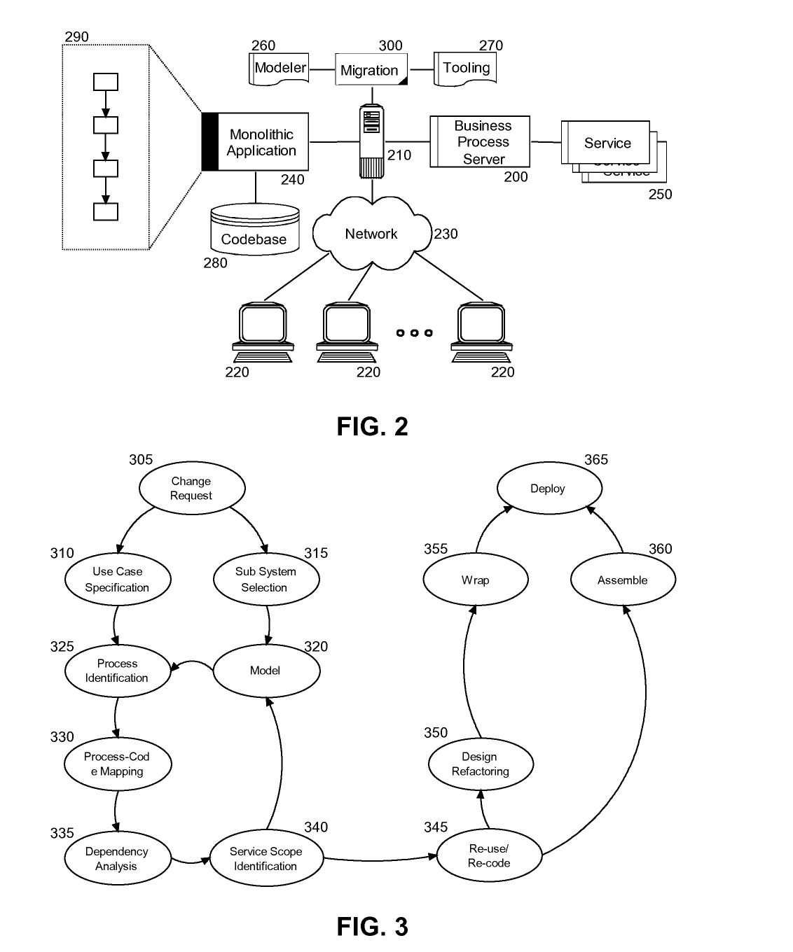

In further illustration, FIG. 2 is an application development data processing system configured for SOA lifecycle model migration. The system can include a host computing platform 210 communicatively coupled to one or more accessing client computing clients 220 over computer communications network 230. The host computing platform 210 can be configured to support the operation of a monolithic application 240. The monolithic application 240 can include one or more components arranged to perform steps in a business process 290. The host computing platform 210 further can include a code base 280 of code assets including computing logic supporting the operation of the monolithic application 240. Yet further, an SOA based system defined by one or more services 250 further can be provided through business process server 200.

Migration logic 300 can be communicatively coupled to the host computing platform 210. The migration logic 300 can include program code enabled to access modeler 260 to model selected components in the monolithic application 240 for migration into an SOA based system and to map the steps of the business process to code segments in the code base 280. The migration logic 300 further can include program code enabled to access development tooling 270 to implement callbacks from code segments of the code base 280 into functionally equivalent services 250 managed by business process server 200.

In yet further illustration, FIG. 3 is a flow chart illustrating a process for SOA lifecycle model migration. Beginning first in step 305, various requests for customizations set forth can be gathered and cataloged based upon the frequency of the change request as well as the perceived importance of the change request. The cataloging of the change requests helps at a later stage of migration when determining which parts of the legacy monolithic application present the most benefit when migrated to an SOA based system as far as increased business agility concerns itself. For instance, a frequency of occurrence for each change request can be quantified and those change requests associated with a threshold frequency can be prioritized over other change requests.

In step 310, the change requests can be represented in the form of use cases in order to obtain a more concrete understanding of the change requests. Doing so allows for an easier mapping between the change requests and the portions of the monolithic application requiring change in order to implement the requests. Concurrently, in step 315 subsystems within the software that are affected by implementing the changes for the change requests can be selected as a subset of the components of the monolithic application in order to narrow the number of components in the monolithic application to migrate to SOA.

In step 320, business processes can be created based on the usage of the selected subsystems using a business process modeling tool. Thereafter, in step 325 individual ones of the created processes can be identified for migration. In identifying processes for migration, the processes can be viewed from the perspective of both technological feasibility and business benefit. Once the processes have been identified, in step 330 a mapping can be defined between the identified processes and the code assets of the legacy monolithic application. To create such a mapping, design patterns and anti-patterns, for instance the Application Service, Session Facade, and Multi-pattern patterns, used in the monolithic application can be leveraged such that a mapping is created between each individual step in the process (as opposed to the decision logic within the process) and corresponding segments of code of the underlying code base.

Subsequent to code mapping, in step 335 a dependency analysis can be applied to the code assets of the code base for the monolithic application in order to gain an understanding of the constraints placed on providing call backs within the code assets for use by external Services in the SOA based application. In this regard, the code can include determining the tightly or loosely coupled nature of the code assets. Once the code analysis has completed, in step 340 the scope of Services required to call back into the code assets can be identified. For example, externalizing a process can involve representing the logic in the modeling tool according to business process execution language (BPEL) and implementing the steps within the process as callbacks in the code assets of the monolithic application where feasible according to the determined tightly or loosely coupled nature of the code assets.

Once it is known that each of the needed Service definitions can be provided despite the coupled nature of the code assets, existing tradeoffs can be considered in regard to the question of whether, though possible, the step should be implemented in the form of a callback. This step provides different criteria to bear in mind when deciding whether to implement the steps in a process as callbacks from an SOA process server to the legacy monolithic application, or as a re-implementation of the steps in the process directly on the SOA process server. In step 350, the existing code base can be modified to allow for the necessary process externalization in the form of callbacks. In particular, the code of the code base can be re-factored through the definition of entry and exit points for respective callbacks, or the code of the code base can be encapsulated as code for Services.

As a final phase of migration, the new processes can be implemented in a tooling for developing SOA-based systems and the re-factoring of the monolithic application can be applied as previously determined. Specifically, in step 355 the necessary Services can be created and in step 360 the new processes can be created for the SOA process server. The new process can be assembled both to perform callbacks into the wrapped Services and to define the externalization of business policies for increased runtime configurability. Finally, the dependencies between various service-components created can be defined and deployed in step 365 onto the SOA process server.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for migrating a process model in a monolithic application to a services oriented architecture (SOA) lifecycle model in an SOA based system, the method comprising:
selecting process steps implemented by code assets in a code base for the monolithic application;
mapping the selected process steps to corresponding ones of the code assets;
determining entry and exit points in the code assets for establishing callbacks into services defining the SOA based system;
establishing callbacks to the determined entry and exit points; and,
deploying the services.

2. The method of claim 1, wherein selecting process steps implemented by code assets in a code base for the monolithic application, comprises selecting a subset of the process steps for migration to the SOA based system.

3. The method of claim 2, wherein selecting a subset of the process steps for migration to the SOA based system, comprises:
quantifying a frequency of requested change requests for the different process steps; and,
selecting process steps for inclusion in the subset according to a quantified threshold frequency of requested change requests.

4. The method of claim 1, wherein establishing callbacks to the determined entry and exit points, comprises:
determining a feasibility of establishing the callbacks; and,
establishing callbacks only where feasible for different ones of the code assets and otherwise re-coding remaining ones of the code assets for deployment in a business process server for the SOA based system.

5. A migration data processing system configured for migrating a process model in a monolithic application to a services oriented architecture (SOA) lifecycle model in an SOA based system, the system comprising:
a monolithic application comprising a code base of code assets implementing a plurality of process steps;
an SOA lifecycle model comprising a plurality of services configured for invoking code implementing selected ones of the process steps using both code disposed in a process server for the SOA based system and also individual ones of the code assets via callbacks to entry points in the individual ones of the code assets; and,
migration logic comprising program code enabled to map selected ones of the process steps to corresponding ones of the code assets, to determine entry and exit points in the code assets for establishing callbacks into the services, to establishing the callbacks, and to deploy the services.

6. A computer program product comprising a computer usable medium embodying computer usable program code for migrating a process model in a monolithic application to a services oriented architecture (SOA) lifecycle model in an SOA based system, the computer program product comprising:
computer usable program code for selecting process steps implemented by code assets in a code base for the monolithic application;
computer usable program code for mapping the selected process steps to corresponding ones of the code assets;
computer usable program code for determining entry and exit points in the code assets for establishing callbacks into services defining the SOA based system;
computer usable program code for establishing callbacks to the determined entry and exit points; and,
computer usable program code for deploying the services.

7. The computer program product of claim 6, wherein the computer usable program code for selecting process steps implemented by code assets in a code base for the monolithic application, comprises computer usable program code for selecting a subset of the process steps for migration to the SOA based system.

8. The computer program product of claim 7, wherein the computer usable program code for selecting a subset of the process steps for migration to the SOA based system, comprises:
computer usable program code for quantifying a frequency of requested change requests for the different process steps; and,
computer usable program code for selecting process steps for inclusion in the subset according to a quantified threshold frequency of requested change requests.

9. The computer program product of claim 7, wherein the computer usable program code for establishing callbacks to the determined entry and exit points, comprises:
computer usable program code for determining a feasibility of establishing the callbacks; and,
computer usable program code for establishing callbacks only where feasible for different ones of the code assets and otherwise re-coding remaining ones of the code assets for deployment in a business process server for the SOA based system.
